(19) United States
(12) Patent Application Publication
(10) Pub. No.: US 2006/0091875 A1
(43) Pub. Date: May 4, 2006

(54) Reference voltage circuit

(75) Inventor: Katsuji Kimura, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kanagawa (JP)

(21) Appl. No.: 11/261,506

(22) Filed: Oct. 31, 2005

(30) Foreign Application Priority Data
Nov. 2, 2004 (JP) 319908/2004

(51) Int. Cl. G05F 3/16

(52) U.S. Cl. 323/315

(57) ABSTRACT

A reference voltage circuit includes a first current-voltage converting circuit consisting of a first diode element; a second current-voltage converting circuit consisting of first and second resistances and a second diode element; a third resistance; a first current mirror circuit configured to supply the third resistance with a current which is proportional to a current flowing through the first current-voltage converting circuit or the second current-voltage converting circuit, to generate a reference voltage; and a control section configured to equalize a voltage of the first current-voltage converting circuit and a voltage of the second current-voltage converting circuit. The second diode element and the first resistance are connected in series, and the second resistance is connected in parallel to the series connection of the first resistance and the second diode element.

### BACKGROUND OF THE INVENTION

1. Field of the Invention

The present invention relates to a semiconductor CMOS reference voltage circuit.

2. Description of the Related Art

A conventional CMOS reference voltage circuit is disclosed in detail in Japanese Laid Open Patent Application (JP-A-Heisei, 11-45125, corresponding to U.S. Pat. No. 6,160,391: first conventional example). Since this reference voltage circuit of the first conventional example obtains a reference voltage through current-voltage conversion, this is similar to a further conventional reference voltage circuit of this type, in which a temperature dependency is canceled. However, in this reference voltage circuit of the first conventional example, it is difficult to attain the reference voltage circuit of a small chip area.

In the further conventional reference voltage circuit, a reference current with a positive temperature dependency is converted into a voltage by an output circuit composed of a resistor and a diode (or a transistor that is diode-connected). A voltage drop across the resistor has a positive temperature dependency, and a forward voltage of the diode (or the transistor that is diode-connected) has a negative temperature dependency. Thus, a reference voltage of about ±1.2V was obtained in which the temperature dependencies are canceled by adding both of them.

On the other hand, the reference voltage circuit disclosed in Japanese Laid Open Patent Application (JP-A-Heisei, 11-45125) generates a reference current that does not substantially have a temperature dependency, and the reference current is converted into a reference voltage of any voltage value by an output circuit composed of only resistors. Thus, the reference voltage circuit of this conventional example is excellent in that it can operates under the power supply voltage of 1.2V or less and the temperature dependency is canceled. The inventor of the present application reports it as [Current Mode Type Reference Voltage Circuit] in [Analog Circuit Design Technique for CMOS Circuit in Mobile Radio Terminal] (Triceps Corporation, 1999), as soon as this reference voltage circuit is laid open, and describes the detailed circuit analysis. Here, the operation of the reference voltage circuit disclosed in Japanese Laid Open Patent Application (JP-A-Heisei, 11-45125) will be described in accordance with the report.

In FIG. 1, an operational amplifier DA1 controls common gate voltages of transistors P₁, P₂ so as to attain V_{A}=V_{B}. Thus,
V_{A}=V_{B} (1)
I₁=I₂ (2)
Also, the current I₁ is separated into a current I_{1A} flowing through a diode D₁ and a current I_{1B} flowing through a resistor R₄. Similarly, the current I₂ is separated into a current I_{2A} commonly flowing through a series connection of a resistor R1 and N diodes D₂ which are connected in parallel and a current I_{2B} flowing through a resistor R₂.
Here, assuming R₂=R₄ (3)
I_{1A}=I_{2A} (4)
and
I_{1B}=I_{2B} (5)
Also,
V_{A}=V_{F1} (6)
V_{B}=V_{F2}+ΔV_{F} (7)
Thus, ΔV_{F}=V_{F1}−V_{F2} (8)
Since the voltage drop across R₁ is ΔV_{F},
I_{2A}=ΔV_{F}/R₁ (9)
I_{1B}=I_{2B}=ΔV_{F}/R₂ ( 10)
Here, ΔV_{F}=V_{T}ln(N) (11)
In this case, V_{T} is a thermal voltage, and represented below.
V_{T}=kT/q (12)
where T is an absolute temperature [K], k is a Boltzmann's constant, and q is a unit electron charge.

Thus, I₃ (=I₂) is converted into a voltage by the resistor R₃, and the voltage is represented as shown below.

$$\begin{matrix}{V}_{REF} = {R}_{3} * {I}_{3} \\ = {R}_{3} \{ {V}_{F1} / {R}_{2} + ( {V}_{T} ln ( N ) ) / R1 \} \\ = ( {R}_{3} / {R}_{2} ) \{ {V}_{F1} + ( {R}_{2} / {R}_{1} ) ( {V}_{T} ln ( N ) ) \}\end{matrix} \qquad ( 13 )$$

Here, {V_{F1}+(R₂/R₁)(V_{T}ln(N))} is a voltage value of about ±1.2V in which the temperature dependency is canceled. Specifically, the voltage V_{F1} has the negative temperature dependency of about −1.9 mV/° C., and the voltage V_{T} has the positive temperature dependency of 0.0853 mV/° C. Thus, in order to cancel the temperature dependency, the value of (R₂/R₁)ln(N) must be 22.3. Also, since the thermal voltage V_{T} is 26 mV at the room temperature, (R₂/R₁) (V_{T}ln(N)) is about 580 mV at the room temperature. Thus, when the voltage V_{F1} is assumed to be 620 mV at the room temperature, {V_{F1}+(R₂/R₁)(V_{T}ln(N))} is about 1.2V.

Also, since the resistor ratio (R₃/R₂) does not have the temperature dependency, the outputted reference voltage V_{REF} is also the voltage that does not have the temperature dependency. Here, the resistor ratio (R₃/R₂) can be arbitrarily set. When 1<(R₃/R₂) is set, the voltage V_{REF} is a voltage higher than 1.2V, and when 1>(R₃/R₂) is set, the voltage V_{REF} is a voltage lower than 1.2V.

In the reference voltage circuit, the ratio between a density of the current flowing through the diode D₁ and a density of the current flowing through the diode D₂ is desired to be large. That is, the difference between the voltage drop by the diode D₁ and the voltage drop by the diodes D₂ is desired to be large. For this reason, the reference voltage circuit disclosed in Japanese Laid Open Patent Application (JP-A-Heisei, 11-45125) is designed in such a manner that the diode D₂ is composed of many (for example, N) diodes, and the current densities of the respective diodes D₂ are reduced to make the voltage drop across the diode D₂ small. As a specific value of N, N=10 is described. However, when the circuit is actually realized (IEEE Symposium on VLSI circuits 1998, May), N=100 is used. Miniaturization in the CMOS process has been advanced to reduce a MOS transistor in size. However, the size of the diode using a parasitic bipolar element is incomparably large as compared with the MOS transistor. Also, the ratio N of the diodes D₁ and D₂ is required to be large, such as one digit or two digits. Thus, the chip area becomes huge.

### SUMMARY OF THE INVENTION

In an aspect of the present invention, a reference voltage circuit includes a first current-voltage converting circuit consisting of a first diode element; a second current-voltage converting circuit consisting of first and second resistances and a second diode element; a third resistance; a first current mirror circuit configured to supply the third resistance with a current which is proportional to a current flowing through the first current-voltage converting circuit or the second current-voltage converting circuit, to generate a reference voltage; and a control section configured to equalize a voltage of the first current-voltage converting circuit and a voltage of the second current-voltage converting circuit. The second diode element and the first resistance are connected in series, and the second resistance is connected in parallel to the series connection of the first resistance and the second diode element.

Here, the first diode element may be a first diode or and a first bipolar transistor which is connected to form a diode, and the second diode element may be a second diode or and a second bipolar transistor which is connected to form a diode.

Also, the control section may include a differential amplifier or an operational amplifier.

Also, the control section may include a current mirror circuit containing the first current mirror circuit; and a second current mirror circuit self-biased by the current mirror circuit.

Also, the control section compares the current flowing through the first current-voltage converting circuit with the current flowing through the second current-voltage converting circuit by a second current mirror circuit, and equalizes the voltage of the first current-voltage converting circuit and the voltage of the second current-voltage converting circuit by biasing a third current mirror circuit by a comparing result of the second current mirror circuit.

Also, the control section may include a second current mirror circuit self-biased by an inverse Widlar current mirror circuit which may include the first current mirror circuit.

In another aspect of the present invention, a reference voltage circuit includes a first current-voltage converting circuit consisting of a first diode element; a second current-voltage converting circuit consisting of first and second resistances and a second diode element; a third resistance; a first current mirror circuit configured to supply the third resistance with a current which is proportional to a current flowing through the first current-voltage converting circuit or the second current-voltage converting circuit, to generate a reference voltage; and a control section configured to equalize a voltage of the first current-voltage converting circuit and a voltage of the second current-voltage converting circuit. The second resistance is connected with the second diode element in parallel, and the second resistance is connected in series with a parallel connection of the first resistance and the second diode element.

Here, the first diode element may be a first diode or and a first bipolar transistor which is connected to form a diode, and the second diode element may be a second diode or and a second bipolar transistor which is connected to form a diode.

Also, the control section may include a differential amplifier or an operational amplifier.

Also, the control section may include a current mirror circuit containing the first current mirror circuit; and a second current mirror circuit self-biased by the current mirror circuit.

Also, the control section compares the current flowing through the first current-voltage converting circuit with the current flowing through the second current-voltage converting circuit by a second current mirror circuit, and equalizes the voltage of the first current-voltage converting circuit and the voltage of the second current-voltage converting circuit by biasing a third current mirror circuit by a comparing result of the second current mirror circuit.

Also, the control section may include a second current mirror circuit self-biased by an inverse Widlar current mirror circuit which may include the first current mirror circuit.

In another aspect of the present invention, a reference voltage circuit includes a first current-voltage converting circuit consisting of a first bipolar transistor; a second current-voltage converting circuit consisting of first and second resistances and a second bipolar transistor which is connected to form a diode; a third resistance; a control section configured to equalize a voltage of the first current-voltage converting circuit and a voltage of the second current-voltage converting circuit; a first current mirror circuit configured to supply the third resistance with a current which is proportional to a current flowing through the first current-voltage converting circuit or the second current-voltage converting circuit, to generate a reference voltage; and a third bipolar transistor whose base is connected to an output of the first current-voltage converting circuit, and whose collector drives the first current mirror circuit. The second bipolar transistor is connected in series with the first resistance, and the second resistance is connected in parallel to the series connection of the first resistance and the second bipolar transistor.

In another aspect of the present invention, a reference voltage circuit includes a first current-voltage converting circuit consisting of a first bipolar transistor; a second current-voltage converting circuit consisting of first and second resistances and a second bipolar transistor which is connected to form a diode; a third resistance; a control section configured to equalize a voltage of the first current-voltage converting circuit and a voltage of the second current-voltage converting circuit; a first current mirror circuit configured to supply the third resistance with a current which is proportional to a current flowing through the first current-voltage converting circuit or the second current-voltage converting circuit, to generate a reference voltage; and a third bipolar transistor whose base is connected to an output of the first current-voltage converting circuit, and whose collector drives the first current mirror circuit. The first resistance is connected in parallel with the second bipolar transistor, and the second resistance is connected in series with the parallel connection of the first resistance and the second bipolar transistor.

In another aspect of the present invention, a reference voltage circuit includes a first current-voltage converting circuit consisting of a first resistance and a first diode element; a second current-voltage converting circuit consisting of second and third resistances and a second diode element; a fourth resistance; a control section configured to equalize a voltage of the first current-voltage converting circuit and a voltage of the second current-voltage converting circuit; and a first current mirror circuit configured to supply the fourth resistance with a current which is proportional to a current flowing through the first current-voltage converting circuit or the second current-voltage converting circuit, to generate a reference voltage. The first resistance and the first diode element are connected with each other in parallel, and the second resistance is connected in series with the second diode element, and the third resistance is connected in parallel with the series connection of the first resistance and the second diode element. Also, the control section compares the current flowing through the first current-voltage converting circuit and the current flowing through the second current-voltage converting circuit by a second current mirror circuit, and equalize the voltage of the first current-voltage converting circuit and the voltage of the second current-voltage converting circuit, by biasing a third current mirror circuit based on the comparing result of the second current mirror circuit.

Here, the first diode element may be a first diode or and a first bipolar transistor which is connected to form a diode, and the second diode element may be a second diode or and a second bipolar transistor which is connected to form a diode.

In another aspect of the present invention, a reference voltage circuit includes a first current-voltage converting circuit consisting of a first resistance and a first diode element; a second current-voltage converting circuit consisting of second an third resistances and a second diode element; a fourth resistance; a control section configured to equalize a voltage of the first current-voltage converting circuit and a voltage of the second current-voltage converting circuit; and a first current mirror circuit configured to supply the fourth resistance with a current which is proportional to a current flowing through the first current-voltage converting circuit or the second current-voltage converting circuit, to generate a reference voltage. The first resistance and the first diode element are connected with each other in parallel, and the second resistance is connected in series with the second diode element, and the third resistance is connected in parallel with the series connection of the first resistance and the second diode element. The control section may include a second current mirror circuit which is self-biased by an inverse Widlar current mirror circuit which contains the first current mirror circuit.

Here, the first diode element may be a first diode or and a first bipolar transistor which is connected to form a diode, and the second diode element may be a second diode or and a second bipolar transistor which is connected to form a diode.

### BRIEF DESCRIPTION OF THE DRAWINGS

FIG. 1 is a circuit diagram showing the configuration of a conventional reference voltage circuit;

FIG. 2 is a circuit diagram showing the configuration of a reference voltage circuit according to a first embodiment of the present invention;

FIG. 3 is a circuit diagram showing the configuration of the reference voltage circuit according to a second embodiment of the present invention;

FIG. 4 is a circuit diagram showing the configuration of the reference voltage circuit according to a third embodiment of the present invention;

FIG. 5 is a circuit diagram showing the configuration of the reference voltage circuit according to a fourth embodiment of the present invention;

FIG. 6 is a circuit diagram showing the configuration of the reference voltage circuit according to a fifth embodiment of the present invention;

FIG. 7 is a circuit diagram showing the configuration of the reference voltage circuit according to a sixth embodiment of the present invention;

FIG. 8 is a circuit diagram showing the configuration of the reference voltage circuit according to a seventh embodiment of the present invention;

FIG. 9 is a circuit diagram showing the configuration of the reference voltage circuit according to an eighth embodiment of the present invention;

FIG. 10 is a circuit diagram showing the configuration of the reference voltage circuit according to a ninth embodiment of the present invention;

FIG. 11 is a circuit diagram showing the configuration of the reference voltage circuit according to a tenth embodiment of the present invention;

FIG. 12 is a circuit diagram showing the configuration of a circuit when a self-biasing method shown in FIGS. 6 and 7 is applied to the circuit shown in FIG. 1; and

FIG. 13 is a circuit diagram showing the configuration of a circuit when a self-biasing method shown in FIGS. 8 and 9 is applied to the circuit shown in FIG. 1.

### DESCRIPTION OF THE PREFERRED EMBODIMENTS

Hereinafter, a reference voltage circuit of the present invention will be described in detail, with reference to the attached drawings.

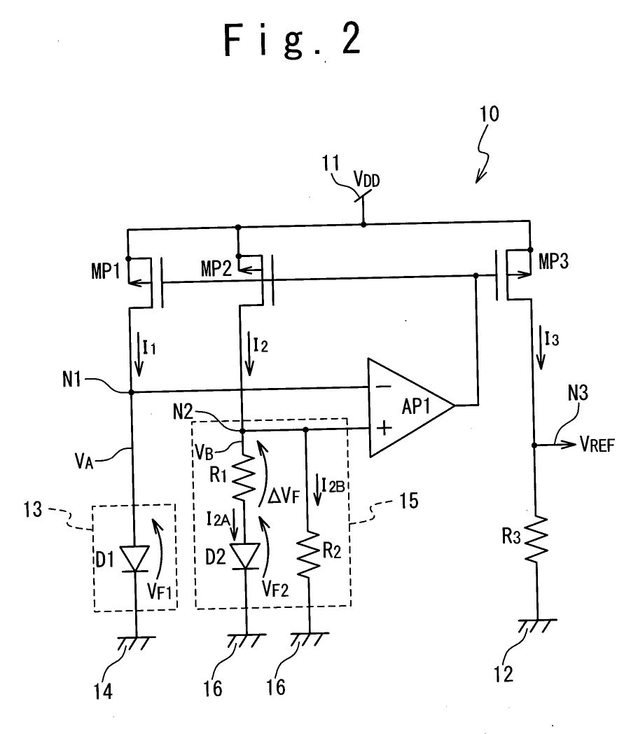

FIG. 2 is a circuit diagram showing the configuration of a CMOS reference voltage circuit according to the first embodiment of the present invention. With reference to FIG. 2, the CMOS reference voltage circuit in the first embodiment contains an operational amplifier AP₁, P-channel CMOS transistors MP₁ to MP₃, diodes D₁ and D₂ and resistors R₁ to R₃. Each of the diodes D₁ and D₂ are single and may be a bipolar transistor that is diode-connected. Hereafter, unless being specifically referred, the diode includes the bipolar transistor that is diode-connected.

The P-channel MOS transistors MP₁ to MP₃ whose sources are connected to a power supply voltage V_{DD} configure a current mirror circuit. The diode D₁ is provided between the drain of the CMOS transistor MP₁ and a ground (GND). The diode D₁ constitutes a first current-voltage converter 13. A series circuit of the resistor R₁ and the diode D₂ and the resistor R₂ connected to the series circuit in parallel are connected between the drain of the MOS transistor MP₂ and the ground. The circuit composed of the resistor R₁, the diode D₂ and the resistor R₂ configures a second current-voltage converter 15. A node N₁ between the MOS transistor MP₁ and the first current-voltage converter 13 is connected to an inversion input terminal of the operational amplifier AP₁. A node N₂ between the MOS transistor MP₂ and the second current-voltage converter 15 is connected to a non-inversion input terminal of the operational amplifier AP₁. An output terminal of the operational amplifier AP₁ is connected to the gates of the MOS transistors MP₁ to MP₃. The resistor R₃is connected between the drain of the MOS transistor MP₃ and the ground, and a reference output voltage V_{REF} is outputted from a node N₃ between the MOS transistor MP₃ and the resistor R₃.

A gate voltage common to the MOS transistors MP₁ to MP₃ is controlled by the operational amplifier AP₁ so that the two input terminal voltages of the operational amplifier AP₁ become equal, and thereby the current flowing through each of the MOS transistors MP₁ to MP₃ is controlled.

Assuming that forward voltages of the diodes D₁ and D₂ are V_{F1} and V_{F2} and the currents flowing through the MOS transistors MP₂ and MP₃ are equal, the following equation (14) is met.

$$\begin{matrix}{I}_{2} = {I}_{3} \\ = {V}_{F1} / {R}_{2} + ( {V}_{F1} - {V}_{F2} ) / {R}_{1} \\ = \{ {V}_{F1} + ( {R}_{2} / {R}_{1} ) Δ {V}_{F} \} / {R}_{2}\end{matrix} \qquad ( 14 )$$

Here, the voltage V_{F1} has the temperature dependency of about −1.9 mV/° C. Also, the voltage V_{F2} has the temperature dependency of about −1.9 mV/° C.

Assuming that both of the diodes D₁ and D₂ are the unit diodes, the following equation (15) is met.
ΔV_{F}=V_{T}ln{I₁/(I₂−V_{F1}/R₂)} (15)
Here, assuming that I₁=I₂, a relation of I₁>(I₂−V_{F1}/R₂) is met and a relation of I₁/(I₂−V_{F1}/R₂)>1 is met. Therefore, the ln item of the equation (15) is understood to be always positive (>0). That is, the voltage ΔV_{F} has a positive temperature dependency even in this circuit, as well known. Thus, this temperature dependency is approximately proportional to a thermal voltage V_{T} (its temperature dependency is 0.00853 mv/° C). That is, the temperature dependency of the item of {V_{F1}+(R₂/R₁)ΔV_{F}}/R₂ in the equation (14) can be substantially canceled by setting the resistor ratio (R₂/R₁) and carrying out a weight addition of the voltage V_{F1} having the negative temperature dependency and the voltage ΔV_{F} having the positive temperature dependency.

Here, if temperature dependency of the item of {V_{F1}+(R₂/R₁)ΔV_{F}}/R₂ in the equation (14) can be canceled, the currents I₂ and I₃ do not substantially have any temperature dependency except the temperature dependency caused by the resistor R₂. The operational condition of the second current-voltage converter driven by the current I₂ is same as the operational condition of the conventional technique. Here, the diodes D₁ and D₂ are the unit diodes and their current densities are naturally different, and the current density of the diode D₂ is reduced by a current flowing through the resistor R₂. Thus, as mentioned above, even in case of I₁=I₂, a relation of V_{F1}>V_{F2} is always met.

The reference voltage V_{REF} outputted at this time is represented as shown below.

$$\begin{matrix}{V}_{REF} = {R}_{3} * {I}_{3} \\ = ( {R}_{3} / {R}_{2} ) * \{ {V}_{F1} + ( {R}_{2} / {R}_{1} ) Δ {V}_{F} \}\end{matrix} \qquad ( 16 )$$

where assuming that the voltage VF₂ is about 580 mV at the room temperature, the voltage V_{F1} is 620 mV at the room temperature, and it could be understood that {V_{F1}+(R₃/R₁)ΔV_{F}} is about 1.2V, similarly to the explanation of the conventional examples. Also, since the resistor ratio (R₃/R₂) does not have the temperature dependency, the output reference voltage V_{REF} becomes a voltage in which the temperature dependencies are canceled.

Here, the resistor ratio (R₃/R₂) can be optionally set. If 1<(R₃/R₂) is set, the V_{REF} is the voltage higher than 1.2V. If 1>(R₃/R₂) is set, the reference voltage V_{REF} is a voltage lower than 1.2V, similar to the conventional examples. In particular, if 1>(R₃/R₂) is set such that the V_{REF} is lower than 1.2V, the power supply voltage is decreased. For example, if V_{REF}=1.0 V is set, the reference voltage circuit can operate from the power supply voltage of about 1.2V.

By the way, in order to realize the nonlinear temperature characteristic of the forward voltage V_{F} of the diode, for example, the slightly convex characteristic obtained by correcting the characteristic in which the dull property in the temperature change to a lower temperature, that is, the characteristic which has a peak at the room temperature and is slightly dropped on the lower and higher temperature side, the current ratio of the current mirror circuit composed of the MOS transistors MP₁ and MP₂ is sometimes required to be slightly changed from 1:1. Or, in order to make the current densities of the diodes D₁ and D₂ largely different, the transistor size of the MOS transistor MP₁ is set to be greater than the transistor size of the MOS transistor MP₂. Of course, the method of connecting the N D₂ unit diodes in parallel and making the current densities of D₁ and D₂ greatly different is still effective. However, in this case, the current larger than the current flowing through the diode D₂ originally flows through the diode D₁. Therefore, it is sufficient that this N value is not in a range of 10 to 100 but may be a small natural number. Also, since the resistor connected in parallel to the diode D₁ can be omitted, the chip area can be reduced.

To simplify the operation explanation, the simple current mirror circuit is used in the above, in FIG. 2. However, in recent years, the fine structure of the CMOS process has been remarkably advanced, which results in the easy introduction of the influence of a channel length modulation in a transistor. For example, in the circuit of FIG. 2, the MOS transistors MP₁ and MP₂ have a same drain-source voltage. However, their drain-source voltages differ from that of the MOS transistor MP₃. In particular, at the time of the temperature variation, the drain-source voltages of the transistors MP₁, MP₂ and MP₃ are varied due to the variations caused by the temperature dependencies of the forward voltages of the diodes. Thus, there is the influence of the channel length modulation of the transistor, although it is very small, from the viewpoint of the strict consideration. Therefore, use of a cascade current mirror circuit and the like as the current mirror circuit is usually adopted to reduce this influence.

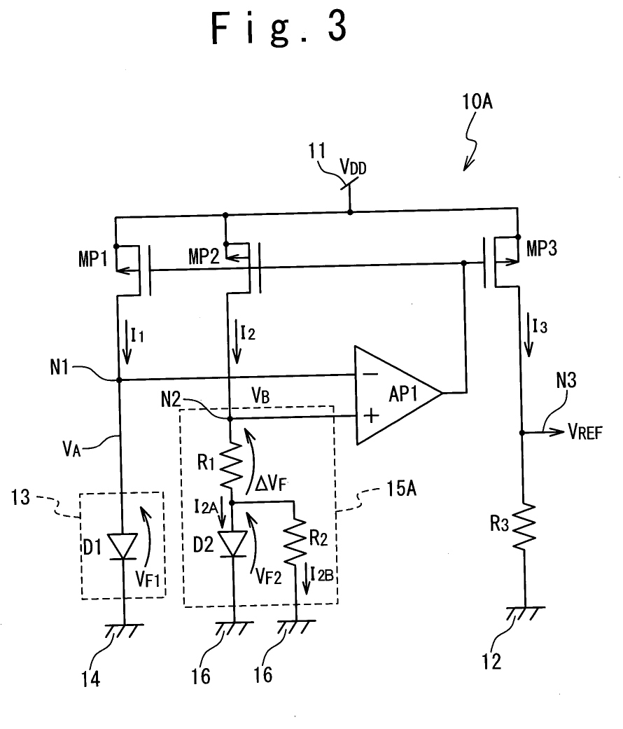

A reference voltage circuit according to the second embodiment of the present invention will be described below. Although the second embodiment is similar to the first embodiment, a second current-voltage converter 15A is used instead of the second current-voltage converter 15 in the first embodiment, as shown in FIG. 3. In the second current-voltage converter 15A, the resistor R₂ is connected in parallel to the diode D₂ and the parallel circuit is connected in series to the resistor R₁. Here, assuming that the both of the diodes D₁ and D₂ are the unit diodes, the MOS transistors MP₁ and MP₂ are controlled by the operational amplifier AP₁ so that the two input terminal voltages are equal. If the currents of the MOS transistors MP₂ and MP₃ are equal, the following equation is met.

$$\begin{matrix}{I}_{2} = {I}_{3} \\ = ( {V}_{F1} - {V}_{F2} ) / {R}_{1} \\ = Δ {V}_{F} / {R}_{1}\end{matrix} \qquad ( 17 )$$

The voltage V_{F1} has a temperature dependency of about −1.9 mV/° C., and the voltage V_{F2} also has a temperature dependency of about −1.9 mV/° C.

In this case, assuming that the both of the diodes D₁ and D₂ are the unit diodes, the following equation is met.
ΔV_{F}=V_{T}ln{T₁/(I₂−V_{F2}/R₂)} (18)
If I₁=I₂, a relation I₁>(I₂−V_{F2}/R₂) is always met. Thus, a relation I₁/(I₂−V_{F2}/R₂)}>1 is met, and the 1n item of the equation (18) is always positive (>0). That is, the following equation is met.
ΔV_{F}=V_{T}ln[1/{1−V_{F2}/(I₂R₂)}] (18′)
The equation (17) is different in form from the equation (14). The voltage difference ΔV_{F} indicated in the equation (18)′ does not have the positive temperature dependency. The reason that the voltage difference ΔV_{F} does not substantially have the temperature dependency will be described below.

In the equation (18′), the thermal voltage V_{T} has the positive temperature dependency (+0.0853 mV/° C.) proportional to the temperature. Also, the voltage V_{F2} in [] has the negative temperature dependency of about −1.9 mV/° C. For the easy explanation, if the temperature dependency of the resistor R₂ is small to an ignoble extent, since R₂>>R₁, the product of I₂R₂ is a value exceeding the voltage V_{F2} (namely, I₂R₂>V_{F2}). Thus, when the value of 1/{1−V_{F2}/(I₂R₂)} takes a value greater than 1, for example, the value takes 2 (in case of I₂R₂=0.5V_{F2}) or 3 (in case of I₂R₂=0.667V_{F2}), the temperature is assumed to be changed with the thus-set value as the center. In this case, ln[1/(1−V_{F2}/(I₂R₂)}] is also varied. This variation region lies in the region where the inclination is relatively large in the function of ln[1/{1−V_{F2}/(I₂R₂)}]. For example, even if the desirable current I₂ does not have the temperature dependency, the temperature dependency of the voltage V_{F2} changes {1−V_{F2}/(I₂R₂)} depending on the temperature. That is, due to this temperature dependency, [1/{1−V_{F2}/(I₂R₂)}] has the negative temperature dependency. Therefore, {1−V_{F2}/(I₂R₂)} also has the negative temperature dependency, and becomes large as the temperature is decreased and becomes small as the temperature is increased.

The current I₂ is a sum of the current flowing through the unit diode D₂ and the current flowing through the resistor R₂ connected in parallel to the unit diode D₂. The control is carried out in such a manner that the current I₁ flowing through the unit diode D₁ and this current I₂ are equal to each other. Thus, the current I₂ does not substantially have the temperature dependency because the temperature dependency of the current flowing through the resistor R₂ (the negative temperature dependency based on the voltage V_{F2} having the negative temperature dependency) and the temperature dependency of the current flowing through the resistor R₂ (the positive temperature dependency opposite to the voltage V_{F2}) are canceled. At this time, the temperature dependencies are substantially canceled. Then, the value [1/{1−V_{F2}/(I₂R₂)}] in [] of ln[1/{1−V_{F2}/(I₂R₂)}] becomes greater as the temperature becomes lower, and becomes smaller as the temperature becomes higher. Here, by properly setting the values of the resistors R₁ and R₂, it is possible to absorb the variation caused by the temperature dependency of the ln[] item so as to substantially cancel the positive temperature dependency (the temperature dependency is 0.0853 mV/° C.) of the thermal voltage V_{T}. That is, the voltage difference ΔV_{F} does not have the temperature dependency. The reference voltage V_{REF} outputted at this time is represented as shown below.

$$\begin{matrix}{V}_{REF} = {R}_{3} * {I}_{3} \\ = ( {R}_{3} / {R}_{1} ) Δ {V}_{F}\end{matrix} \qquad ( 19 )$$

Also, since the resistor ratio (R₃/R₁) does not have the temperature dependency, the reference voltage V_{REF} is also a voltage where the temperature dependencies are canceled. Here, the resistor ratio (R₃/R₁) can be optionally set, and the voltage difference ΔV_{F} is a voltage from about several 10 mV to one hundred and several 10 mV. Thus, by setting (R₃/R₁)>1((R₃/R₁)>1), the reference voltage V_{REF} can be set to a voltage lower than 1.0 V. In this case, the power supply voltage can be decreased. For example, when V_{REF}=1.0V is set, the reference voltage circuit can operate in the power supply voltage of about 1.2V.

The reference voltage circuit according to the third embodiment of the present invention will be described below. In the reference voltage circuit according to the third embodiment in which a topology (D₁, {(R₁−D₂)//R2}) is used in which the diode D₁ is used and the second current-voltage converter in which the resistor R₂ is connected in parallel to a series connection of the diode D₂ and the resistor R₁, the operational amplifier AP₁ is omitted through a self-biasing method.

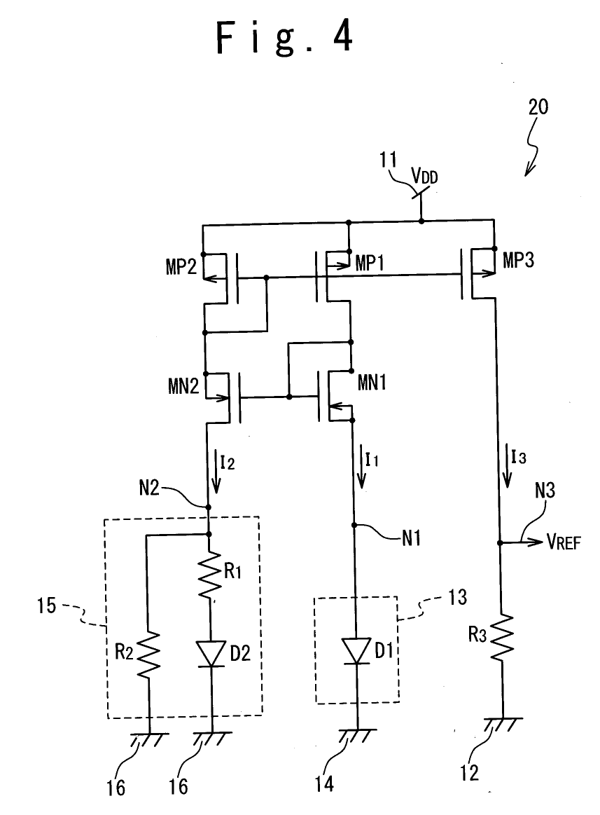

FIG. 4 shows one example of the reference voltage circuit using the self-biasing method according to the third embodiment. However, for the simple description, a start-up circuit is omitted. In FIG. 4, the operational amplifier AP₁ is omitted, and N-channel MOS transistors MN₁ and MN₂ are added. In the P-channel transistors MP₁ to MP₃ whose sources are connected to the power supply V_{DD}, their gates are commonly connected, and the gate and drain of the transistor MP₂ are commonly connected. The gates of the N-channel MOS transistors MN₁ and MN₂ are commonly connected. The gate and drain of the transistor MN₁ are commonly connected. The drain of the N-channel MOS transistor MN₁ is connected to the drain of the P-channel MOS transistor MP₁, and the source of the N-channel MOS transistor MN₁ is connected to the first current-voltage converter 13. The drain of the N-channel MOS transistor MN₂ is connected to the drain of the P-channel MOS transistor MP₁, and the source of the N-channel MOS transistor MN₁ is connected to the second current-voltage converter 15.

Thus, the P-channel transistors MP₁ and MP₂ and the N-channel transistors MN₁ and MN₂ constitute the current mirror circuits, respectively. The current mirror circuit composed of the P-channel transistors MP₁ and MP₂ self-biases the current mirror circuit composed of the N-channel transistors MN₁ and MN₂. Consequently, the currents flowing through the N-channel transistors MN₁ and MN₂ are proportional to each other. When the transistor sizes of the N-channel transistors MN₁ and MN₂ are equal and the transistor sizes of the P-channel transistors MP₁ and MP₂ are equal, the currents flowing through the N-channel transistors MN₁ and MN₂ become equal to each other. In any event, since they are self-biased, the voltages between the gates and the sources of the respective N-channel transistors MN₁ and MN₂ become equal to each other. The voltage applied to the first current-voltage converter 13, namely, the diode D₁ is equal to the voltage applied to the second current-voltage converter 15, namely, the circuit {(R₁−D₂)//R₂} in which the resistor R₁ is connected in series to a parallel circuit of the diode D₂ and the resistor R₂. Thus, the same operation condition as in the foregoing operational amplifier can be attained in (D₁, {(R₁−D₂)//R₂}). Thus, the characteristics are obtained which is similar to the reference voltage circuit in the first embodiment shown in FIG. 2. It should be noted that the diode D₁ and the circuit {(R₁−D₂)//R₂} may be driven by any of the N-channel transistors MN₁ and MN₂.

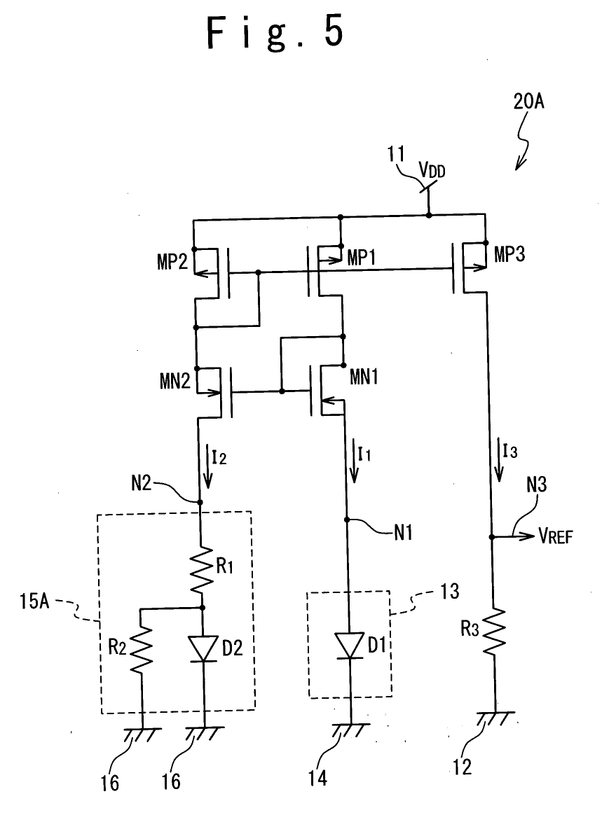

The reference voltage circuit according to the fourth embodiment of the present invention will be described below. In the reference voltage circuit according to the fourth embodiment, the circuit topology (D₁, {R₁−(D₂//R2)}) in which the first current-voltage converter 13 has the diode D₁ and the second current-voltage converter 15A has a series circuit of the resistor R₁ and a parallel circuit of the diode D₂ and the resistor R₂ is self-biased. Thus, the operational amplifier can be omitted as shown in FIG. 5.

In the P-channel transistors MP₁ to MP₃ whose sources are connected to the power supply V_{DD}, their gates are commonly connected, and the gate and drain of the transistor MP₂ are commonly connected. The gates of the N-channel MOS transistors MN₁ and MN₂ are commonly connected. The gate and drain of the transistor MN₁ are commonly connected. The drain of the N-channel MOS transistor MN₁ is connected to the drain of the P-channel MOS transistor MP₁, and the source of the N-channel MOS transistor MN₁ is connected to the first current-voltage converter 13. The drain of the N-channel MOS transistor MN₂ is connected to the drain of the P-channel MOS transistor MP₁, and the source of the N-channel MOS transistor MN₁ is connected to the second current-voltage converter 15A. Thus, the P-channel transistors MP₁ and MP₂ and the N-channel transistors MN₁ and MN₂ constitute the current mirror circuits, respectively. The current mirror circuit composed of the P-channel transistors MP₁ and MP₂ self-biases the current mirror circuit composed of the N-channel transistors MN₁ and MN₂. Consequently, the currents flowing through the N-channel transistors MN₁ and MN₂ are proportional to each other. When the transistor sizes of the N-channel transistors MN₁ and MN₂ are equal and the transistor sizes of the P-channel transistors MP₁ and MP₂ are equal, the currents flowing through the N-channel transistors MN₁ and MN₂ become equal to each other. In any event, since self-bias is carried out, the voltages between the gates and the sources of the respective N-channel transistors MN₁ and MN₂ become equal to each other. The voltage applied to the first current-voltage converter 13, namely, the diode D₁ is equal to the voltage applied to the second current-voltage converter 15A, namely, the circuit {(R₁−D₂)//R₂} in which the resistor R₁ is connected in series to the parallel circuit of the diode D₂ and the resistor R₂. The same operation condition as in use of the foregoing operational amplifier can be attained in (D₁, {(R₁−D₂)//R₂}). Thus, the characteristics are obtained which are similar to the reference voltage circuit in the first embodiment shown in FIG. 3. It should be noted that the diode D₁ and the circuit {(R₁−D₂)//R₂} may be driven by any of the N-channel transistors MN₁ and MN₂. The influence of the channel length modulation of the transistor easily appears in the reference voltage circuit shown in FIGS. 4 and 5.

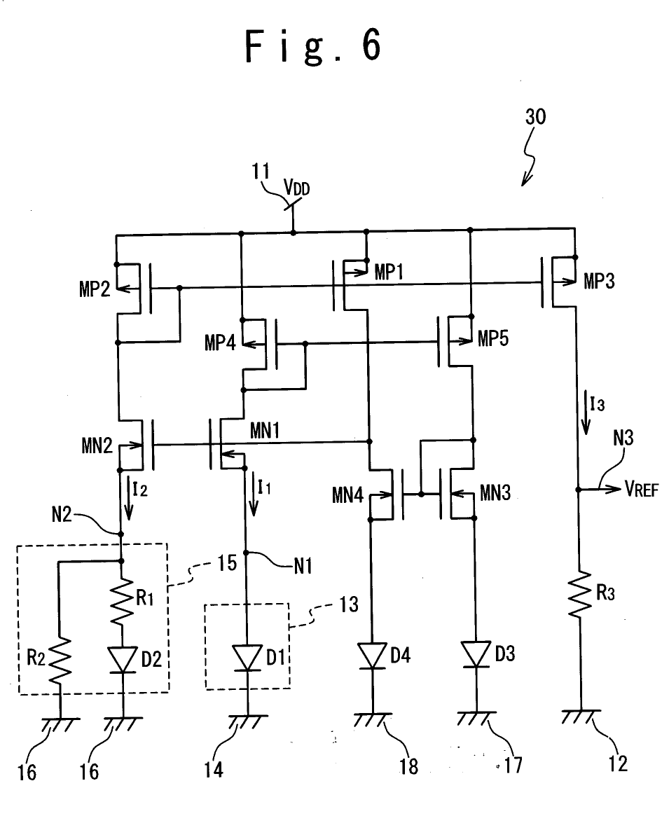

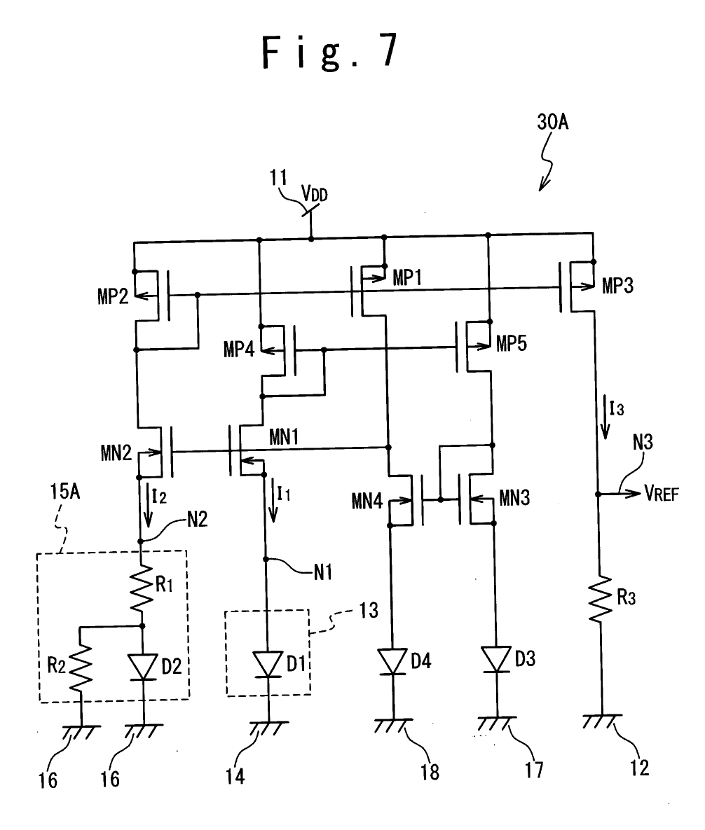

The reference voltage circuits according to the fifth embodiment and the sixth embodiment of the present invention will be described below, with reference to FIGS. 6 and 7. In those embodiments, the influence of the channel length modulation is reduced. Here, the start-up circuit is omitted for the simple explanation.

With reference to FIG. 6, the P-channel transistors MP₁ to MP₃ whose sources are connected to the power supply V_{DD} constitute the current mirror circuit, and the gate of the P-channel transistor MP₂ is connected to the drain thereof. The P-channel transistors MP₄ and MP₅ constitute the current mirror circuit, the sources of the transistors MP₄ and MP₅ are connected to the power supply V_{DD}, the gate of the transistors MP₄ and MP₅ are commonly connected, and the gate of the transistor MP₄ is connected to the drain thereof. The drains of the N-channel transistors MN₂ and MN₁ are connected to the drains of the transistors MP₂ and MP₄, and the gates of the N-channel transistors MN₂ and MN₁ are commonly connected. The second current-voltage converter 15 and first current-voltage converter 13 in the first embodiment are connected to the sources of the N-channel transistors MN₂ and MN₁, respectively. The drains of the N-channel transistors MN₄ and MN₃ are connected to the drains of the transistors MP₁ and MP₅, respectively. The gates of the N-channel transistors MN₄ and MN₃ are commonly connected. The gate of the transistor MN₃ is connected to the drain thereof, and the drain of the transistor MN₄ is connected to the gates of the transistors MN₁ and MN₂. Diodes D₄ and D₃ are connected between the sources of the N-channel transistors MN₄ and MN₃ and the ground, respectively. The transistor MP₃ is similar to the foregoing embodiment.

The currents flowing through the respective N-channel transistors MN₁ and MN₂ are current-compared by the current mirror circuit composed of the N-channel transistors MN₃ and MN₄, through the current mirror circuit composed of the P-channel transistors MP₄ and MP₅ and the current mirror circuit composed of the P-channel transistors MP₁ and MP₂. Thus, the common gate voltage of the N-channel transistors MN₁ and MN₂ is controlled such that the currents flowing through the respective N-channel transistors MN₁ and MN₂ are equal to each other. Thus, the voltages between the respective gates and sources of the N-channel transistors MN₁ and MN₂ become equal to each other. Therefore, the voltage applied to the diode D₁ is equal to the voltage applied to the second current-voltage converter {(R1−D2)//R2} 15 in which the resistor R₂ is connected in parallel to the series connection of the diode D₂ and the resistor R₁. The same operation condition in a case of using the foregoing operational amplifier can be attained in (D1, {(R1−D2)//R2}). Thus, the characteristics similar to FIG. 2 can be obtained and the reference voltage circuit is realized. Here, the diodes D₃ and the D₄ are inserted so as to equalize the drain voltages of the N-channel transistors MN₃ and MN₄. It should be noted that the diode D₁ and {(R1−D2)//R2} may be driven by any of the N-channel transistors MP₁ and MP₂.

FIG. 7 shows the reference voltage circuit according to the sixth embodiment. The reference voltage circuit according to the sixth embodiment is similar to the reference voltage circuit according to the fifth embodiment. However, this is different in that the second current-voltage converter 15 is changed to the second current-voltage converter 15A.

The currents flowing through the respective N-channel transistors MN₁ and MN₂ are current-compared by the current mirror circuit composed of the N-channel transistors MN₃ and MN₄, through the current mirror circuit composed of the P-channel transistors MP₁ and MP₂ and the current mirror circuit composed of the P-channel transistors MP₄ and MP₅. The common gate voltage of the N-channel transistors MN₁ and MN₂ is controlled such that the currents flowing through the respective N-channel transistors MN₁ and MN₂ are equal to each other. Thus, the voltages between the respective gates and sources of the N-channel transistors MN₁ and MN₂ become equal to each other. Then, the voltage applied to the diode D₁ of the first current-voltage converter 13 is equal to the voltage applied to the circuit {R1−(D2//R2)} in which the resistor R₁ is connected in series to the parallel connection of the diode D₂ and resistor R₂ in the second current-voltage converter 15A. The same operation condition as in a case of using the foregoing operational amplifier can be attained in {R1−(D2//R2) }). Thus, the characteristics similar to FIG. 3 can be obtained and the reference voltage circuit is realized. Here, the diodes D₃ and D₄ are inserted so as to equalize the drain voltages of the N-channel transistors MN₃ and MN₄. It should be noted that the D₁ and {R1−(D2//R2)} may be driven by any of the N-channel transistors MN₁ and MP₂.

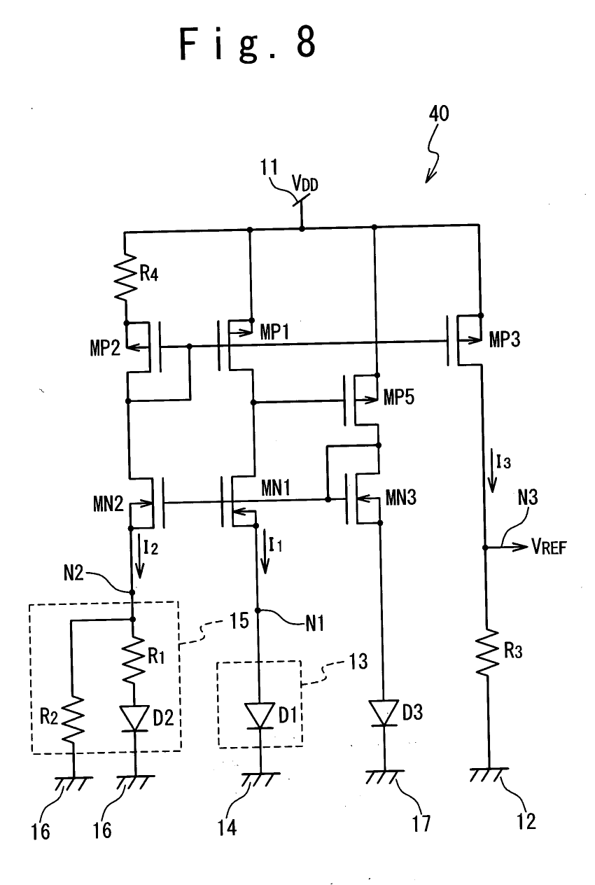

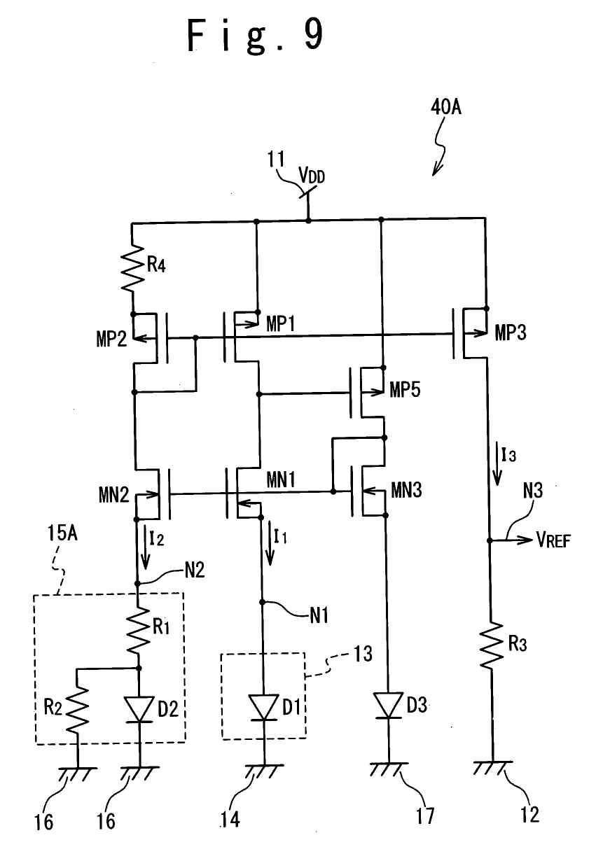

The reference voltage circuits according to the seventh embodiment and the eighth embodiment of the present invention will be described below, with reference to FIGS. 8 and 9. In those embodiments, the influence of the channel length modulation is reduced. Here, the start-up circuit is omitted for the simple explanation.

With reference to FIG. 8, in the reference voltage circuit according to the seventh embodiment of the present invention, the gates of the P-channel transistors MP₁ to MP₃ are commonly connected. A resistor R₄ is connected between the source of the P-channel transistor MP₂ and the power supply V_{DD}, and the gate of the transistor MP₂ is connected to the drain. The sources of the P-channel transistors MP₁ and MP₃ and MP₅ are connected to the power supply V_{DD}. The drains of the P-channel transistors MP₂ and MP₁ and MP₅ are connected to the drains of the N-channel transistors MN₂ and MN₁ and MN₃, respectively. The gate of the transistor MP₅ is connected to the drain of the transistor MP₁. The gate of the transistor MN₃ is connected to the drain thereof and connected to the gates of the transistors MN₁ and MN₂. The source of the transistor MN₃ is connected through the diode D₃ to the ground. The other connections are similar to those of the first embodiment.

Since the gate voltages of the P-channel transistors MP₁ to MP₃ are common, the transistor size of the P-channel transistor MP₂ is set to be larger than the transistor size of the P-channel transistor MP₁ so that the same current can be supplied. Here, the current mirror circuit composed of the P-channel transistors MP₂ and MP₁ constitutes the inverse Widlar current mirror circuit. Thus, when the current flowing through the N-channel transistor MN₂ is increased, the current flowing through the P-channel transistor MP₂ is increased by the increase. However, since the current flowing through the P-channel transistor MP₁ becomes larger than it, the increased current cannot flow through the N-channel transistor MN₁. Thus, the drain voltage of the P-channel transistor MP₁ becomes higher, and the current flowing through the P-channel transistor MP₅ whose gate is connected to the drain of the P-channel transistor MP₁ is decreased. Therefore, the current flowing through the N-channel transistor MN₃ whose drain current is common is also decreased. The N-channel transistor MN₃ and the N-channel transistor MN₁ constitute the current mirror circuit, and the gate voltage is common in the N-channel transistor MN₁ and the N-channel transistor MN₂. Thus, the common gate voltage of the N-channel transistors MN₁ to MN₃ is decreased, thereby decreasing the current flowing through the N-channel transistor MN₂. That is, the current loop composed of the N-channel transistors MN₁ to MN₃ and the P-channel transistors MP₁ to MP₃ and MP₅ constitute the negative feedback circuit. Thus, the common gate voltage of the N-channel transistors MN₁ and MN₂ is controlled such that the currents of the N-channel transistor MN₁ and the N-channel transistor MN₂ become predetermined values (in this example, they are equal to each other) through the opposite wide current mirror circuit.

Thus, the voltages between the respective gates and sources of the N-channel transistors MN₁ and MN₂ become equal to each other. Also, the voltage applied to the first current-voltage converter 13 having the diode D₁ is equal to the voltage applied to the second current-voltage converter 15 {(R1−D2)//R2} in which the resistor R₂ is connected in parallel to the series connection of the diode D₂ and the resistor R₁. The same operation condition as in case of using the foregoing operational amplifier can be attained in (D1, {(R1−D2)//R2}). Thus, the characteristics similar to FIG. 2 can be obtained and the reference voltage circuit is realized. Here, the diode D₃ is inserted such that the gate voltage of the N-channel transistor MN₃ is equal to the gate voltages of the N-channel transistors MN₁ and MN₂. It should be noted that the diode D₁ and {(R1−D2)//R2} may be driven by any of the N-channel transistors MN₁ and MN₂.

Next, the reference voltage circuit according to the eighth embodiment will be described below with reference to FIG. 9. The configuration of the reference voltage circuit in the eighth embodiment is similar to that of the reference voltage circuit according to the seventh embodiment. The difference lies in the configuration that the second current-voltage converter 15 is replaced by the second current-voltage converter 15A. The resistor R₄ is inserted between the source of the P-channel transistor MP₂ and the power supply V_{DD}, and has the gate voltage common to the P-channel transistor MP₁. Thus, in order to supply the same current, the transistor size of the P-channel transistor MP₂ is set to be larger than the transistor size of the P-channel transistor MP₁. Here, the current mirror circuit composed of the P-channel transistors MP₂ and MP₁ constitutes the inverse Widlar current mirror circuit. Thus, when the current flowing through the N-channel transistor MN₂ is increased, the current flowing through the P-channel transistor MP₂ is increased in correspondence to that increase. However, since the current flowing through the P-channel transistor MP₁ becomes larger than it, the increased current cannot flow through the N-channel transistor MN₁. Thus, the drain voltage of the P-channel transistor MP₁ becomes higher, and the current flowing through the P-channel transistor MP₅ whose gate is connected to the drain of the P-channel transistor MP₁ is decreased. Therefore, the current flowing through the N-channel transistor MN₃ whose drain current is common is also decreased. Here, the N-channel transistor MN₃ and the N-channel transistor MN₁ constitute the current mirror circuit, and the gate voltage is common in the N-channel transistor MN₁ and the N-channel transistor MN₂. Thus, the common gate voltage of the MN₁ to MN₃ is decreased, thereby decreasing the current flowing through the N-channel transistor MN₂. That is, the current loop composed of the N-channel transistors MN₁ to MN₃ and the P-channel transistors MP₁ to MP₃ and MP₅ constitute the negative feedback circuit. In this case, the common gate voltage of the N-channel transistors MN₁ and MN₂ is controlled such that the currents of the N-channel transistor MN₁ and MN₂ become predetermined values (in this example, they are equal to each other), through the inverse Widlar current mirror circuit. Thus, the voltages between the respective gates and sources of the N-channel transistors MN₁ and MN₂ become equal. Then, the voltage applied to the diode D₁ of the first current-voltage converter 13 is equal to the voltage applied to the circuit {R1−(D2//R2)} having the resistor R₁ connected in series to the parallel connection of the diode D₁ and resistor R₂ of the second current-voltage converter 15A. The operation condition equal to the case of using the foregoing operational amplifier can be attained in (D1, {R1−(D2//R2)}). Thus, the property similar to FIG. 3 can be obtained to attain the reference voltage circuit. Here, the diode D₃ is inserted such that the gate voltage of the N-channel transistor MN₃ is equal to the gate voltages of the N-channel transistors MN₁ and MN₂. It should be noted that the D₁ and {R1−(D2//R2)} may be driven by any of the N-channel transistors MN₁ and MN₂.

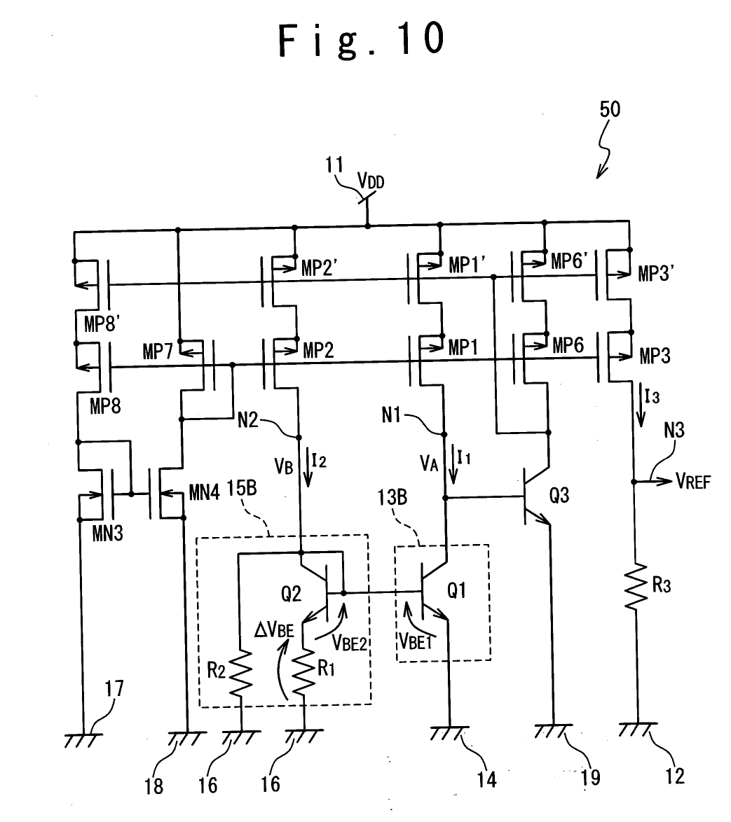

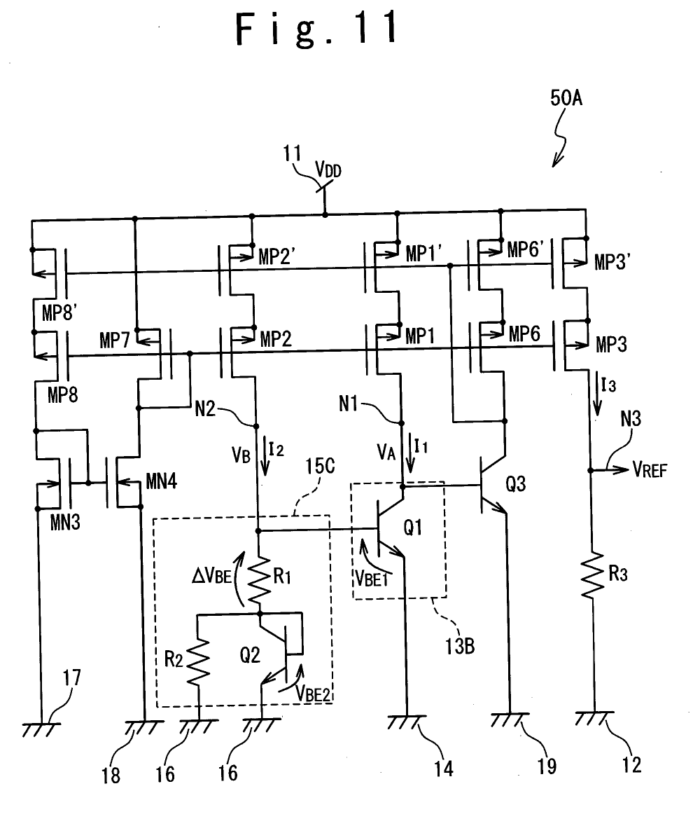

The reference voltage circuits in the ninth embodiment and the tenth embodiment of the present invention will be described below with reference to FIGS. 10 and 11. The lower voltage operation is attained by replacing the diodes in the foregoing embodiments with bipolar transistors. The start-up circuit is omitted for the simple description.

With reference to FIG. 10, in the reference voltage circuit according to the ninth embodiment of the present invention, sources of P-channel transistors MP₁′, MP₂′, MP₃′, MP₆′. MP₇ and MP₈′ are connected to the power supply V_{DD}, and gates of the transistors except the transistor MP₇ are connected to each other. Drains of the P-channel transistors MP₁′, MP₂′, MP₃′, MP₆′ and MP₈′ are connected to sources of P-channel transistors MP₁, MP₂, MP₃, MP₆ and MP₈, respectively. Gates of the P-channel transistors MP₁, MP₂, MP₃, MP₆, MP₇ and MP₈ are commonly connected. The gate of the transistor MP₇ is connected to the drain thereof, and the drain of the transistor MP₆ is connected to the gate of the transistor MP₆′. The drains of the N-channel transistors MN₃ and MN₄ are connected to the drains of the transistors MP₇ and MP₈, respectively. The gates of the transistors MN₃ and MN₄ are connected to each other and also connected to the drain of the transistor MN₃. The sources of the transistors MN₃ and MN₄ are grounded. The drain of the transistor MP₆ is connected to a connector of a transistor Q₃, and an emitter of the transistor Q₃ is grounded. The drain of the transistor MP₁ is connected to a base of the transistor Q₃ and a first current-voltage converter 13B. The drain of the transistor MP₂ is connected to a second current-voltage converter 15B. The first current-voltage converter 13B has a bipolar transistor Q₁ having a grounded emitter and a collector connected to the drain of the transistor MP₁. The second current-voltage converter 15B has a bipolar transistor Q₂ and resistors R₁ and R₂. A collector of the bipolar transistor Q₂ is connected to the drain of the transistor MP₂ and also grounded through the resistor R₂. Also, an emitter of the bipolar transistor Q₂ is grounded through the resistor R₁. A base of the transistor Q₂ is connected to the collector thereof and also connected to the base of the bipolar transistor Q₁. The drain of the transistor MP₃ is grounded through a resistor R₃.

In FIG. 10, the bipolar transistor Q₂ and the bipolar transistor Q₁ constitute an inverse Widlar current mirror circuit, and a resistor R₂ is inserted between the common base and the ground (GND). Thus, as the current flowing through the cascade-connected transistors MP₂′ and MP₂ is increased, the current flowing through the Q₂ is increased, and the current flowing through the resistor R₂ is increased, which absorbs the increase in the current. Here, since R₂>>R₁, the increase in the voltage drop across the resistor R₁ is small, and the rise in the voltage between the terminals of the resistor R₂ is small. However, the increase in the voltage drop of the resistor R₂ becomes naturally the voltage between the base and the emitter of the bipolar transistor Q₁, and the increase in the current flowing through the bipolar transistor Q₁ becomes the great value. Since the current flowing through the cascade transistors MP₁ and MP₁′ at this time is equal to the current flowing through the cascade transistors MP₂ and MP₂′, the current supplied to the bipolar transistor Q₁ becomes short, which decreases the collector voltage of the bipolar transistor Q₁. Here, since a base of a bipolar transistor Q₃ is connected to the collector of the bipolar transistor Q₁, the current flowing through the bipolar transistor Q₃ is decreased. Here, the bipolar transistor Q₃ drives the self-biased cascade current mirror circuit. Thus, the current flowing through the cascade transistors MP₂ and MP₂′ is decreased and settled to a predetermined current value. That is, the negative current loop is formed between the bipolar transistors Q₁ to Q₃ and the cascade current mirror circuit constituting the self-bias circuit.

Assuming that the current flowing through the cascade transistors MP₂ and MP₂′ at this time is equal to a current I_{OUT} flowing through the cascade transistors MP₃ and MP₃′, the following equation is met.

$$\begin{matrix}{I}_{OUT} = {V}_{BE1} / {R}_{2} + ( {V}_{BE1} - {V}_{BE2} ) / {R}_{1} \\ = \{ {V}_{BE1} + ( {R}_{2} / {R}_{1} ) Δ {V}_{BE} \} / {R}_{2}\end{matrix} \qquad ( 20 )$$

Here, the voltage V_{BE1} has a temperature dependency of about −1.9 mV/° C. Also, the voltage V_{BE2} has a temperature dependency of about −1.9 mV/° C. Assuming that both of the transistors Q₁ and Q₃ are the unit transistors, the following equation is met.
ΔV_{BE}=V_{T}ln{I_{C1}/(I_{C2}−V_{BE1}/R₂)} (21)
Here, if I_{C1}=I_{C2}, since the relation of IC1>(I_{C2}−V_{BE1}/R₂) is always met, I_{C1}/(I_{C2}−V_{BE1}/R₂)}>1 is met. Also, the ln item of the equation (21) is always positive (>0). That is, ΔV_{BE} has the positive temperature dependency even in this equation, as well known. Thus, this temperature dependency is substantially proportional to the thermal voltage V_{T} (its temperature dependency is 0.0853 mV/° C.). That is, the temperature dependency of the item of {V_{BE1}+(R₂/R₁)ΔV_{BE}} in the equation (20) can be substantially canceled by setting the resistor ratio (R₂/R₁) to the voltage V_{BE1} having the negative temperature dependency and the ΔV_{BE} having the positive temperature dependency and then performing the weight addition.

Here, assuming that the temperature dependency of the item of {V_{BE1}+(R₂/R₁)ΔV_{BE}} in the equation (20) can be canceled, the currents I_{C2} and I_{OUT} are the currents without any substantial temperature dependency except the temperature dependency caused by the resistor R₂. At this time, the reference voltage V_{REF} is expressed as shown below.

$$\begin{matrix}{V}_{REF} = {R}_{3} * {I}_{OUT} \\ = ( {R}_{3} / {R}_{2} ) \{ {V}_{BE1} + ( {R}_{2} / {R}_{1} ) Δ {V}_{BE} \}\end{matrix} \qquad ( 22 )$$

Here, assuming that the voltage V_{BE2} is 580 mV at the room temperature, it could be understood that the voltage V_{BE1} is 620 mV at the room temperature and {V_{BE1}+(R₃/R₁)ΔV_{BE}} is similarly about 1.2V. Also, since the resistor ratio (R₃/R₂) does not have the temperature dependency, the reference voltage V_{REF} is also the voltage where the temperature dependencies are canceled. Here, since the resistor ratio (R₃/R₂) can be optionally set, if 1<(R₃/R₂) is set, the reference voltage V_{REF} becomes the voltage higher than 1.2V. If 1>(R₃/R₂) is set, the reference voltage V_{REF} becomes the voltage lower than 1.2V. Those facts are similar to the case of the conventional technique. In particular, in the case of setting 1>(R₃/R₂) where the reference voltage V_{REF} is the voltage lower than 1.2V, the power supply voltage is reduced. For example, when V_{REF}=0.8V is set, since the cascade current mirror circuit is used to bias, the power supply voltage becomes slightly higher. Thus, it can be operated from the power supply voltage of about 1.2V.

Next, with reference to FIG. 11, the reference voltage circuit according to the tenth embodiment of the present invention is similar to the reference voltage circuit according to the ninth embodiment. The difference lies in the configuration where the second current-voltage converter 15B is replaced by a second current-voltage converter 1C. In the second current-voltage converter 1C, one end of a resistor R₁ is connected to a drain of a P-channel transistor MP₂ and a base of a transistor Q₁. The other end of the resistor R₁ is grounded through a resistor R₂ and also connected to a collector of a transistor Q₂. A base of the transistor Q₂ is connected to a collector, and an emitter is grounded.

In FIG. 11, the bipolar transistor Q₂ and the bipolar transistor Q₁ constitute an inverse Widlar current mirror circuit, and the resistor R₂ is inserted between the base of the bipolar transistor Q₂ and the ground (GND). Thus, as the current flowing through the cascade transistors MP₂ and MP₂′ is increased, the current flowing through the Q₂ is increased, and the current flowing through the resistor R₂ is increased, which absorbs the increase in the current. Here, since R₂>>R₁, the increase in the voltage drop of the resistor R₁ is small. Also, since the voltage between the base and the emitter of the bipolar transistor Q₂ is logarithmically compressed with respect to the flowing current, the voltage between the terminals of the resistor R₂ is not substantially increased. However, the increase in the voltage drop of the resistor R₂ becomes naturally the voltage between the base and the emitter of the bipolar transistor Q₁, and the increase in the current flowing through the bipolar transistor Q₁ becomes the great value. Since the current flowing through the cascade transistors MP₁, MP₁′ at this time is equal to the current flowing through the cascade transistors MP₂ and MP₂′, the current supplied to the bipolar transistor Q₁ becomes short, which decreases the collector voltage of the bipolar transistor Q₁. Here, since a base of a bipolar transistor Q₃ is connected to the collector of the bipolar transistor Q₁, the current flowing through the bipolar transistor Q₃ is decreased. Here, the bipolar transistor Q₃ drives the self-biased cascade current mirror circuit. Thus, the current flowing through the cascade transistors MP₂ and MP₂′ is decreased and settled to a predetermined current value. That is, the negative current loop is formed between the bipolar transistors Q₁ to Q₃ and the cascade current mirror circuit constituting the self-bias circuit.

At this time, assuming that the current flowing through the cascade transistors MP₂ and MP₂′ is equal to a current I_{OUT} flowing through the cascade transistors MP₃ and MP₃′, the following equation is met.

$$\begin{matrix}{I}_{OUT} = ( {V}_{BE1} - {V}_{BE2} ) / {R}_{1} \\ = Δ {V}_{BE} / {R}_{1}\end{matrix} \qquad ( 23 )$$

Here, the voltage V_{BE1} has a temperature dependency of about −1.9 mV/° C. Also, the voltage V_{BE2} has a temperature dependency of about −1.9 mV/° C. Here, assuming that both of the Q₁ and Q₂ are the unit transistors, the following equation is met.
ΔV_{BE}=V_{T}ln{I_{C1}/(I_{C2}−V_{BE1}/R₂)} (24)
Here, if I_{C1}=I_{C2}, since always I_{C1}>(I_{C2}−V_{BE2}/R₂), I_{C1}/(I_{C2}−V_{BE2}/R₂)}>1 is established. Also, the ln item of the equation (24) is always positive (>0). That is, the following equation is met.
ΔV_{BE}=V_{T}ln[1/{1−V_{BE2}/(I_{C2}R₂ )}] (24′)
The equation (23) is different in form from the equation (20). The voltage difference ΔV_{BE} shown in the equation (24′) does not have the positive temperature dependency. Here, the fact that the voltage difference ΔV_{BE} does not substantially have the temperature dependency will be described.

In the equation (24′), the thermal voltage V_{T} has the positive temperature dependency (+0.0853 mV/° C.) proportional to the temperature. Also, the voltage V_{BE2} in [] of the equation (24′) has the negative temperature dependency of about −1.9 mV/° C. For the easy explanation, assuming that the temperature dependency of the resistor R₂ is small to an ignorable extent, the product of I_{C2}R₂ becomes the value exceeding the V_{BE2} (I_{C2}R₂>V_{BE2}) since R₂>>R₁. Thus, ln[1/{1−V_{BE2}/(I_{C2}R₂)}] becomes the value that the value of 1/{1−V_{BE2}/(I_{C2}R₂)} is greater than 1, for example, 2 (in case of I_{C2}R₂=0.5V_{BE2}) or 3 (in case of I_{C2}R₂=667V_{BE2}). Then, when the temperature is changed with the thus-set value as the center, it is varied. This variation region lies in the region where the inclination is relatively large in the function of ln[1/{1−V_{BE2}/(I_{C2}R₂)}]. For example, even if the desirable current I_{C2} does not have the temperature dependency, the temperature dependency of the voltage V_{BE2} changes {1−V_{BE2}/(I_{C2}R₂)} depending on the temperature. That is, with this temperature dependency, [1−V_{BE2}/(I_{C2}R₂)}] has the negative temperature dependency. Therefore, ln[1/{1−V_{BE2}/(I_{C2}R₂)}] also has the negative temperature dependency. Thus, as the temperature is decreased, it becomes large, and as the temperature is increased, it becomes small.

Here, the current I_{C2} is a sum of the current flowing through the unit diode D₂ and the current flowing through the resistor R₂ connected in parallel to the unit transistor Q₂. Thus, since the current I_{C1} flowing through the unit transistor Q₁ and the current I_{C2} are controlled to be equal to each other, the temperature dependency of the I_{C2} does not substantially have the temperature dependency because the temperature dependency of the current flowing through the resistor R₂ (the negative temperature dependency based on the voltage V_{BE2} having the negative temperature dependency) and the temperature dependency of the current flowing through the resistor R₂ (the positive temperature dependency opposite to the voltage V_{BE2}) are canceled. At this time, the temperature dependencies are substantially canceled. Thus, the value [1/{1−V_{BE2}/(I_{C2}R₂)}] in [] of ln[1/{1−V_{BE2}/(I_{C2}R₂)}] becomes greater as the temperature becomes lower, and it becomes smaller as the temperature becomes higher. Here, by setting the values of the resistors R₁ and R₂, it is possible to absorb the variation caused by the temperature of the ln[] so as to substantially cancel the positive temperature dependency (the temperature dependency is 0.0853 mV/° C.) of the thermal voltage V_{T}. That is, the voltage difference ΔV_{BE} becomes the voltage that the temperature dependencies are substantially canceled.

At this time, the reference voltage V_{REF} is represented as shown below.

$$\begin{matrix}{V}_{REF} = {R}_{3} * {I}_{OUT} \\ = ( {R}_{3} / {R}_{1} ) Δ {V}_{F}\end{matrix} \qquad ( 25 )$$

Also, since the resistor ratio (R₃/R₁) does not have the temperature dependency, the reference voltage V_{REF} is also the voltage that the temperature dependencies are canceled. Here, the resistor ratio (R₃/R₁) can be optionally set, and the voltage difference ΔV_{BE} is the voltage from about several 10 mV to one hundred and several 10 mV. In such a case, by setting (R₃/R₁)>1 ((R₃/R₁)>1), the reference voltage V_{REF} can be set to the voltage lower than 1.0V. In this case, the power supply voltage can be dropped. For example, when the reference voltage V_{REF}=1.0V is set, the reference voltage circuit can operate from the power supply voltage of about 1.2V.

As mentioned above, the circuits shown in FIGS. 10 and 11 have the intention of suppressing the influence of the channel length modulation, and show the case of the self-biasing in the cascade current mirror circuit. Of course, the method of using the above-mentioned cascade current mirror circuit can be applied to all of the reference voltage circuits as explained above. Also, they correspond to the case of bi-CMOS where the N-channel transistors and the P-channel transistors are used. However, they can be attained even by the bipolar process if the PNP transistors can be formed in addition to the NPN transistors.

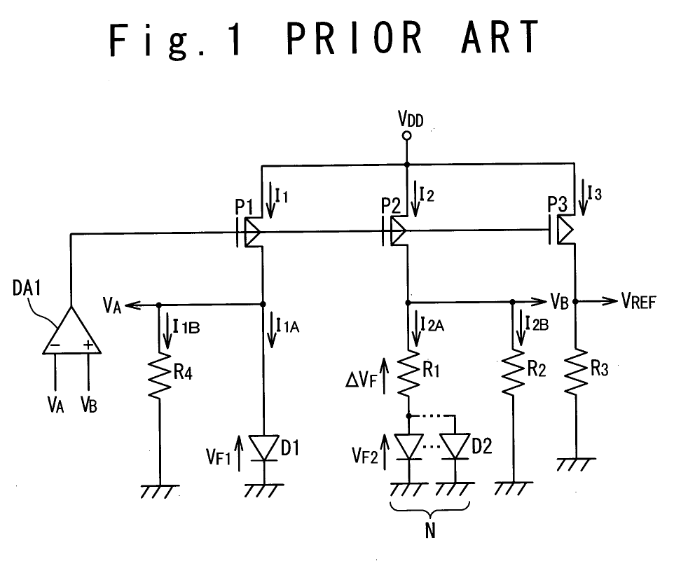

Finally, the operational amplifier can be omitted when the self-biasing method is applied to the circuit of the conventional example shown in FIG. 1. However, in order to make the current densities between the diodes different, about 10 to 100 diodes D₂ are required to be connected in parallel. Thus, there is no advantage in a chip area. However, the self-biasing method shown in FIGS. 4 and 5 is known because it is described in the technical seminar distribution information (March 2002) written by this inventor, or, in Design Wave Magazine 2002 August (pp. 153-158).

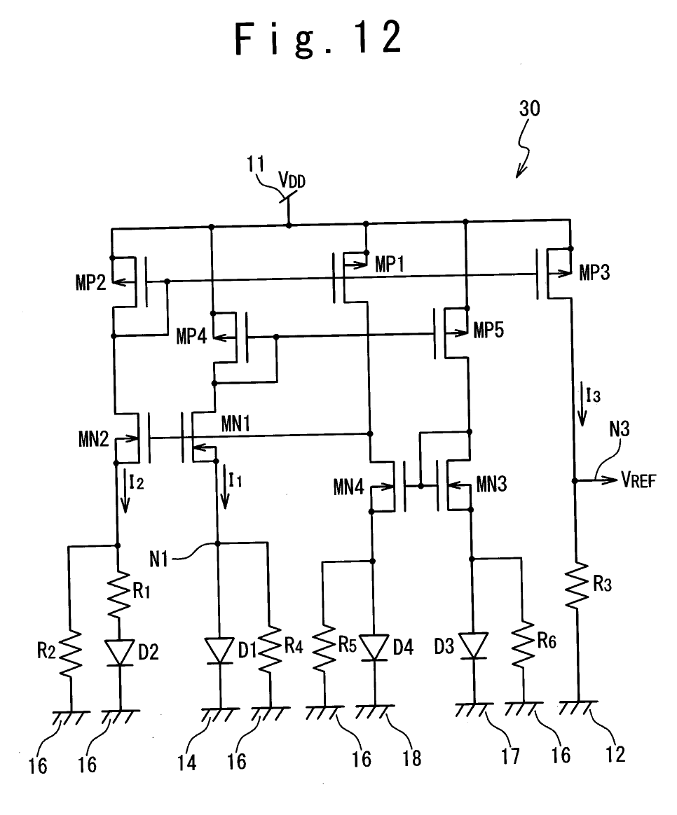

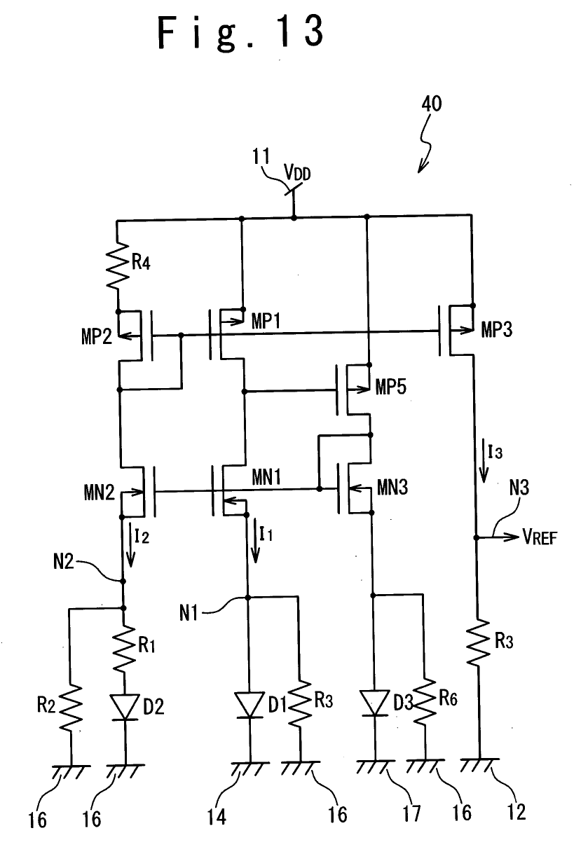

The circuit shown in FIG. 12 is configured when the self-biasing method shown in FIGS. 6 and 7 is applied to the circuit of the conventional example shown in FIG. 1. Similarly to the operation of the circuits shown in FIGS. 6 and 7, the source voltages of the MOS transistors MP₁ and MP₂ are controlled so as to be equal to each other, even in FIG. 12, and the equation (13) is obtained, and the reference voltage circuit can be attained. Moreover, the circuit shown in FIG. 13 is configured when the self-biasing method shown in FIGS. 8 and 9 is applied. Similarly to the operation explanations of the circuits shown in FIGS. 8 and 9, with the self-biasing through the opposite wide current mirror circuit, even in FIG. 13, the source voltages of the MOS transistors MP₁ and MP₂ are controlled so as to be equal to each other, and the equation (13) is obtained, and the reference voltage circuit can be attained.

According to the present invention, the chip area can be reduced. This is because even the use of only two diodes can constitute the circuit.

Also, according to the present invention, it can be operated at the low voltage. This is because the output voltage can be set to any voltage value of 2V or less.

What is claimed is:

1. A reference voltage circuit comprising:
a first current-voltage converting circuit consisting of a first diode element;
a second current-voltage converting circuit consisting of first and second resistances and a second diode element;
a third resistance;
a first current mirror circuit configured to supply said third resistance with a current which is proportional to a current flowing through said first current-voltage converting circuit or said second current-voltage converting circuit, to generate a reference voltage; and
a control section configured to equalize a voltage of said first current-voltage converting circuit and a voltage of said second current-voltage converting circuit,
wherein said second diode element and said first resistance are connected in series, and said second resistance is connected in parallel to the series connection of said first resistance and said second diode element.

2. The reference voltage circuit according to claim 1, wherein said first diode element is a first diode or and a first bipolar transistor which is connected to form a diode, and said second diode element is a second diode or and a second bipolar transistor which is connected to form a diode.

3. The reference voltage circuit according to claim 1, wherein said control section comprises a differential amplifier or an operational amplifier.

4. The reference voltage circuit according to claim 1, wherein said control section comprises:
a current mirror circuit containing said first current mirror circuit; and
a second current mirror circuit self-biased by said current mirror circuit.

5. The reference voltage circuit according to claim 1, wherein said control section compares the current flowing through said first current-voltage converting circuit with the current flowing through said second current-voltage converting circuit by a second current mirror circuit, and equalizes the voltage of said first current-voltage converting circuit and the voltage of said second current-voltage converting circuit by biasing a third current mirror circuit by a comparing result of said second current mirror circuit.

6. The reference voltage circuit according to claim 1, wherein said control section comprises:
a second current mirror circuit self-biased by an inverse Widlar current mirror circuit which comprises said first current mirror circuit.

7. A reference voltage circuit comprising:
a first current-voltage converting circuit consisting of a first diode element;
a second current-voltage converting circuit consisting of first and second resistances and a second diode element;
a third resistance;
a first current mirror circuit configured to supply said third resistance with a current which is proportional to a current flowing through said first current-voltage converting circuit or said second current-voltage converting circuit, to generate a reference voltage; and
a control section configured to equalize a voltage of said first current-voltage converting circuit and a voltage of said second current-voltage converting circuit,
wherein said second resistance is connected with said second diode element in parallel, and said second resistance is connected in series with a parallel connection of said first resistance and said second diode element.

8. The reference voltage circuit according to claim 7, wherein said first diode element is a first diode or and a first bipolar transistor which is connected to form a diode, and said second diode element is a second diode or and a second bipolar transistor which is connected to form a diode.

9. The reference voltage circuit according to claim 7, wherein said control section comprises a differential amplifier or an operational amplifier.

10. The reference voltage circuit according to claim 7, wherein said control section comprises:
a current mirror circuit containing said first current mirror circuit; and
a second current mirror circuit self-biased by said current mirror circuit.

11. The reference voltage circuit according to claim 7, wherein said control section compares the current flowing through said first current-voltage converting circuit with the current flowing through said second current-voltage converting circuit by a second current mirror circuit, and equalizes the voltage of said first current-voltage converting circuit and the voltage of said second current-voltage converting circuit by biasing a third current mirror circuit by a comparing result of said second current mirror circuit.

12. The reference voltage circuit according to claim 7, wherein said control section comprises:
a second current mirror circuit self-biased by an inverse Widlar current mirror circuit which comprises said first current mirror circuit.

13. A reference voltage circuit comprising:
a first current-voltage converting circuit consisting of a first bipolar transistor;
a second current-voltage converting circuit consisting of first and second resistances and a second bipolar transistor which is connected to form a diode;
a third resistance;
a control section configured to equalize a voltage of said first current-voltage converting circuit and a voltage of said second current-voltage converting circuit;
a first current mirror circuit configured to supply said third resistance with a current which is proportional to a current flowing through said first current-voltage converting circuit or said second current-voltage converting circuit, to generate a reference voltage; and
a third bipolar transistor whose base is connected to an output of said first current-voltage converting circuit, and whose collector drives said first current mirror circuit,
wherein said second bipolar transistor is connected in series with said first resistance, and said second resistance is connected in parallel to the series connection of said first resistance and said second bipolar transistor.

14. A reference voltage circuit comprising:
a first current-voltage converting circuit consisting of a first bipolar transistor;
a second current-voltage converting circuit consisting of first and second resistances and a second bipolar transistor which is connected to form a diode;
a third resistance;
a control section configured to equalize a voltage of said first current-voltage converting circuit and a voltage of said second current-voltage converting circuit;
a first current mirror circuit configured to supply said third resistance with a current which is proportional to a current flowing through said first current-voltage converting circuit or said second current-voltage converting circuit, to generate a reference voltage; and
a third bipolar transistor whose base is connected to an output of said first current-voltage converting circuit, and whose collector drives said first current mirror circuit,
wherein said first resistance is connected in parallel with said second bipolar transistor, and said second resistance is connected in series with the parallel connection of said first resistance and said second bipolar transistor.

15. A reference voltage circuit comprising:
a first current-voltage converting circuit consisting of a first resistance and a first diode element;
a second current-voltage converting circuit consisting of second and third resistances and a second diode element;
a fourth resistance;
a control section configured to equalize a voltage of said first current-voltage converting circuit and a voltage of said second current-voltage converting circuit; and
a first current mirror circuit configured to supply said fourth resistance with a current which is proportional to a current flowing through said first current-voltage converting circuit or said second current-voltage converting circuit, to generate a reference voltage,
wherein said first resistance and said first diode element are connected with each other in parallel,
said second resistance is connected in series with said second diode element, and said third resistance is connected in parallel with the series connection of said first resistance and said second diode element, and
said control section compares the current flowing through said first current-voltage converting circuit and the current flowing through said second current-voltage converting circuit by a second current mirror circuit, and equalize the voltage of said first current-voltage converting circuit and the voltage of said second current-voltage converting circuit, by biasing a third current mirror circuit based on the comparing result of said second current mirror circuit.

16. The reference voltage circuit according to claim 15, wherein said first diode element is a first diode or and a first bipolar transistor which is connected to form a diode, and said second diode element is a second diode or and a second bipolar transistor which is connected to form a diode.

17. A reference voltage circuit comprising:
a first current-voltage converting circuit consisting of a first resistance and a first diode element;
a second current-voltage converting circuit consisting of second and third resistances and a second diode element;
a fourth resistance;
a control section configured to equalize a voltage of said first current-voltage converting circuit and a voltage of said second current-voltage converting circuit; and
a first current mirror circuit configured to supply said fourth resistance with a current which is proportional to a current flowing through said first current-voltage converting circuit or said second current-voltage converting circuit, to generate a reference voltage,
wherein said first resistance and said first diode element are connected with each other in parallel,
said second resistance is connected in series with said second diode element, and said third resistance is connected in parallel with the series connection of said first resistance and said second diode element, and
said control section comprises a second current mirror circuit which is self-biased by an inverse Widlar current mirror circuit which contains said first current mirror circuit.

18. The reference voltage circuit according to claim 17, wherein said first diode element is a first diode or and a first bipolar transistor which is connected to form a diode, and said second diode element is a second diode or and a second bipolar transistor which is connected to form a diode.
